(19) United States
(12) Patent Application Publication
(10) Pub. No.: US 2023/0140623 A1
(43) Pub. Date: May 4, 2023

(54) METHOD AND SYSTEM FOR TAMPER-RESISTANT EVENT SOURCING USING A DISTRIBUTED LEDGER

(71) Applicant: MASTERCARD INTERNATIONAL INCORPORATED, Purchase, NY (US)

(72) Inventor: Sébastien LE CALLONNEC, Greystones (IE)

(73) Assignee: MASTERCARD INTERNATIONAL INCORPORATED, Purchase, NY (US)

(21) Appl. No.: 17/518,755

(22) Filed: Nov. 4, 2021

(51) Int. Cl. H04L 9/32; H04L 9/08; H04L 29/08

(52) U.S. Cl. CPC H04L 9/3236; H04L 9/088; H04L 9/3252; H04L 67/26; H04L 2209/38

(57) ABSTRACT

A method for verifying the state of an object through tamper-resistant event sourcing includes: receiving, by a receiver of a processing server, state data for a computing object and an identification value associated with the computing object; applying, by a processor of the processing server, a one-way cryptographic function to the received state data to generate a comparison hash value; identifying, by the processor of the processing server, a published hash value stored in a blockchain with the identification value; and verifying, by the processor of the processing server, a state of the computing object according to the state data based on a match of the generated comparison hash value with the identified published hash value.

### FIELD

The present disclosure relates to event sourcing, specifically event sourcing a computing object, such as an application or system, in a tamper-resistant manner via the use of cryptographic functions and a distributed ledger, such as a blockchain.

### BACKGROUND

Event sourcing systems process incoming events, where each event changes the resulting state of the system, such as an application program, an operating system, or an entire computing system. A record of the events is often stored so that the events can be retraced, such as if the system needs to be rebuilt or a past configuration restored. However, the record of events is only useful if the record can be recovered.

In addition, if an event in the event history is tampered with, such as via corruption or through malice, the resulting state of the system would be corrupt. In some cases, especially if malice is involved, such corruption may be difficult or impossible to detect and could leave the object with vulnerabilities or other problems that may not be readily apparent. As a result, information regarding the state of a computing object needs to be stored in a location that is resistant to tampering and stored in a manner where any tampering to the data could be readily identified. However, there are no systems developed to accomplish such tasks presently.

Thus, there is a need for a technological improvement to the storage and verification of state data for computing objects.

### SUMMARY

The present disclosure provides a description of systems and methods for tamper-resistant event sourcing of objects and verifying the state of an object through tamper-resistant event sourcing. State information for a computing object is obtained after each event that affects the object, or at other regular intervals. The state information is converted and transformed into a suitable format, if applicable, and then has a cryptographic hashing function applied to the transformed state data. This results in a hash value that is stored in a distributed ledger, such as a blockchain, with an identifier that is associated with the computing object and/or current state, such as a timestamp or event identifier. The state of the object can then be verified at any of the intervals by applying the hashing function to the state of the object and then comparing the resulting value with the value stored in the blockchain. Because the blockchain is immutable, the state data cannot be tampered with or changed in any manner. In addition, by hashing the data, the data is protected even in states where the blockchain may be public, which can further enable any entity to verify a state if the state data is provided, providing for greater security and trustworthiness. Furthermore, with a history of state data stored in the blockchain for a single object, if an entity has a version of the object that becomes corrupted, the point of corruption can be quickly identified by verifying the state data at each interval until a verification fails. Thus, the state data for the object is tamper-resistant and allows for verification and error detection with complete immutability.

A method for tamper-resistant event sourcing of an object includes: receiving, by a receiver of a processing server, state data for a computing object and an identification value associated with the computing object; applying, by a processor of the processing server, a one-way cryptographic function to the received state data to generate a hash value; and publishing, by a transmitter of the processing server, the generated hash value and the identification value on a blockchain.

A method for verifying the state of an object through tamper-resistant event sourcing includes: receiving, by a receiver of a processing server, state data for a computing object and an identification value associated with the computing object; applying, by a processor of the processing server, a one-way cryptographic function to the received state data to generate a comparison hash value; identifying, by the processor of the processing server, a published hash value stored in a blockchain with the identification value; and verifying, by the processor of the processing server, a state of the computing object according to the state data based on a match of the generated comparison hash value with the identified published hash value.

A system for tamper-resistant event sourcing of an object includes: a processing server, the processing server including a receiver receiving state data for a computing object and an identification value associated with the computing object, a processor applying a one-way cryptographic function to the received state data to generate a hash value, and a transmitter publishing the generated hash value and the identification value on a blockchain.

A system for verifying the state of an object through tamper-resistant event sourcing includes: a processing server, the processing server including a receiver receiving state data for a computing object and an identification value associated with the computing object, and a processor applying a one-way cryptographic function to the received state data to generate a comparison hash value, identifying a published hash value stored in a blockchain with the identification value, and verifying a state of the computing object according to the state data based on a match of the generated comparison hash value with the identified published hash value.

### BRIEF DESCRIPTION OF THE DRAWING FIGURES

The scope of the present disclosure is best understood from the following detailed description of exemplary embodiments when read in conjunction with the accompanying drawings. Included in the drawings are the following figures:

FIG. 1 is a block diagram illustrating a high level system architecture for tamper-resistant event sourcing in accordance with exemplary embodiments.

FIG. 2 is a block diagram illustrating a processing server of the system of FIG. 1 for enabling tamper-resistant event sourcing of a computing object in accordance with exemplary embodiments.

FIG. 3 is a flow diagram illustrating a process for storing state data for a computing object in a tamper-resistant manner by the processing server in the system of FIG. 1 in accordance with exemplary embodiments.

FIG. 4 is a flow diagram illustrating a process for verifying the state of an object using tamper-resistant event sourcing in the system of FIG. 1 in accordance with exemplary embodiments.

FIG. 5 is a flow chart illustrating an exemplary method for tamper-resistant event sourcing of an object in accordance with exemplary embodiments.

FIG. 6 is a flow chart illustrating an exemplary method for verifying the state of an object through tamper-resistant event sourcing in accordance with exemplary embodiments.

FIG. 7 is a block diagram illustrating a computer system architecture in accordance with exemplary embodiments.

Further areas of applicability of the present disclosure will become apparent from the detailed description provided hereinafter. It should be understood that the detailed description of exemplary embodiments are intended for illustration purposes only and are, therefore, not intended to necessarily limit the scope of the disclosure.

### DETAILED DESCRIPTION

### Glossary of Terms

Blockchain - A public ledger of all transactions of a blockchain-based currency. One or more computing devices may comprise a blockchain network, which may be configured to process and record transactions as part of a block in the blockchain. Once a block is completed, the block is added to the blockchain and the transaction record thereby updated. In many instances, the blockchain may be a ledger of transactions in chronological order, or may be presented in any other order that may be suitable for use by the blockchain network. In some configurations, transactions recorded in the blockchain may include a destination address and a currency amount, such that the blockchain records how much currency is attributable to a specific address. In some instances, the transactions are financial and others not financial, or might include additional or different information, such as a source address, timestamp, etc. In some embodiments, a blockchain may also or alternatively include nearly any type of data as a form of transaction that is or needs to be placed in a distributed database that maintains a continuously growing list of data records hardened against tampering and revision, even by its operators, and may be confirmed and validated by the blockchain network through proof of work and/or any other suitable verification techniques associated therewith. In some cases, data regarding a given transaction may further include additional data that is not directly part of the transaction appended to transaction data. In some instances, the inclusion of such data in a blockchain may constitute a transaction. In such instances, a blockchain may not be directly associated with a specific digital, virtual, fiat, or other type of currency.

### System for Tamper-Resistant Event Sourcing

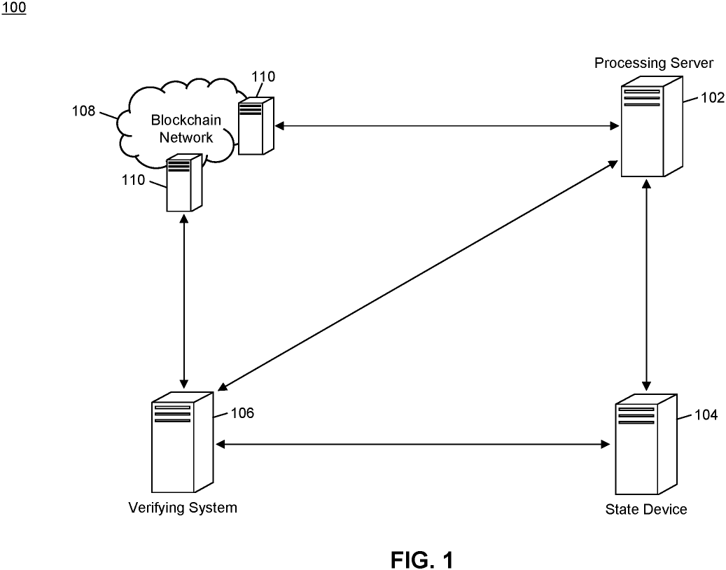

FIG. 1 illustrates a system 100 for the event sourcing of a computing object in a tamper-resistant manner through the use of cryptographic hashing and a blockchain.

The system 100 may include a processing server 102. The processing server 102, discussed in more detail below, may be configured to obtain state data for an object and publish the state data in a tamper-resistant and protected manner to allow for verification of the state data of the object and identification of errors or corruption in events associated with the object. In the system 100, the processing server 102 may receive state data for a computing object, such as a state device 104. The state device 104 may be an entire computing system for which state data is to be sourced or may include an application program, operating system, or other object for which the state data is to be sourced. In some embodiments, the computing object may be a part of the processing server 102 or otherwise interfaced therewith. The state data may be obtained by the processing server 102 from the state device 104 via electronic communication or any other suitable method. The state data may include any and all data regarding a state of the computing object that may be useful in operation of the computing object or verification thereof later on, where the state data may depend on the type of the computing object, needs of associated entities, etc. For instance, the state data of an application program for e-mail communication may differ from the state data for an operating system.

In some cases, the state data for the computing object may be the state of an event sourcing system used for the computing object. For example, an operating system may include an event sourcing system that may track all actions and events that affect the operating system, such as an event log. In such a case, the processing server 102 may use the data for the event log or other event sourcing system as the state data. The state data for the computing object may be stored in any suitable format, such as in a memory or database that is a part of the state device 104 or otherwise accessible thereby, in cloud storage, etc.

As discussed herein, the term “computing object” may refer to a piece of hardware, a software component, an application program, a data object, or any combination thereof. For instance, in one example the computing object may be the state device 104. In a second example, the computing object may be an operating system. In a third example, the computing object may be data associated with a bank account, where the state data may include, for instance, events pertaining to the account including opening of the account, credits to the account, debits from the account, other charges, etc. In a fourth example, the computing object may be a supply chain database, where the state data may include the manufacture date of goods, information on product verification or testing, packaging dates, shipping dates, sale dates, expiration dates, etc.

The processing server 102 may also receive an identification value that is associated with the computing object. The identification value may be a number, alphanumeric value, etc. In some cases, the identification value may be unique to the computing object. In other cases, the identification value may be unique to the computing object and a specific state of the computing object. In such cases, each state of the computing object may be associated with a different, unique identification value. In instances where the identification value is unique to the computing object regardless of state, the processing server 102 may receive a second identifier that is associated with the state of the computing object. In such an instance, the processing server 102 may thus receive an identification value for the computing object that is unique across all computing objects as well as a state identifier that is unique across all states for that specific computing object. In an example, each action or event associated with the computing object that is executed thereon or thereby may have a value associated therewith (e.g., a numerical ordering of the events), where that value may be used as the state identifier. In another example, the state identifier may be a timestamp when the state data was changed to its current state.

The processing server 102 may receive the state data and may apply a cryptographic function, such as a one-way hashing function, to the state data. The application of the cryptographic function may generate a hash value. In an exemplary embodiment, a collision-resistant cryptographic hashing function may be used such that the resulting hash value may be of sufficient size and complexity as to be highly resistant to any collisions (e.g., resulting in the same hash value when the function is applied to two different sets of data). In an example, the cryptographic function may be Secure Hash Algorithm 256 (SHA-256). The cryptographic function may be a one-way function, which means that the resulting hash value cannot be used to obtain the original state data via any algorithm, function, or other mechanism.

In some embodiments, the processing server 102 may format the state data prior to applying the cryptographic function. To format the state data, the processing server 102 may first convert the state data of the computing object into an object notation representation, such as a JavaScript Object Notation (JSON) representation. In some cases, the conversion may only be performed depending on the location of the state data when obtained by the processing server 102 or other current representation of the state data when obtained by the processing server 102. After conversion of the state data to its object notation representation, the processing server 102 may then transform the state data into a canonical representation. In instances where the object notation representation is a JSON representation, the transformation of the state data may follow rules of the JSON Canonicalization Scheme (JCS). In other instances, any applicable rules or standards may be utilized when transforming the state data into a canonical representation. In such embodiments, the canonical representation of the state data may be used when the cryptographic function is applied to the state data.

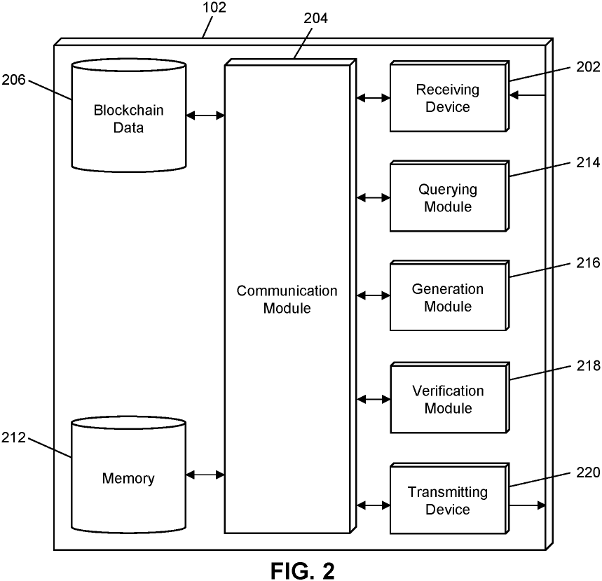

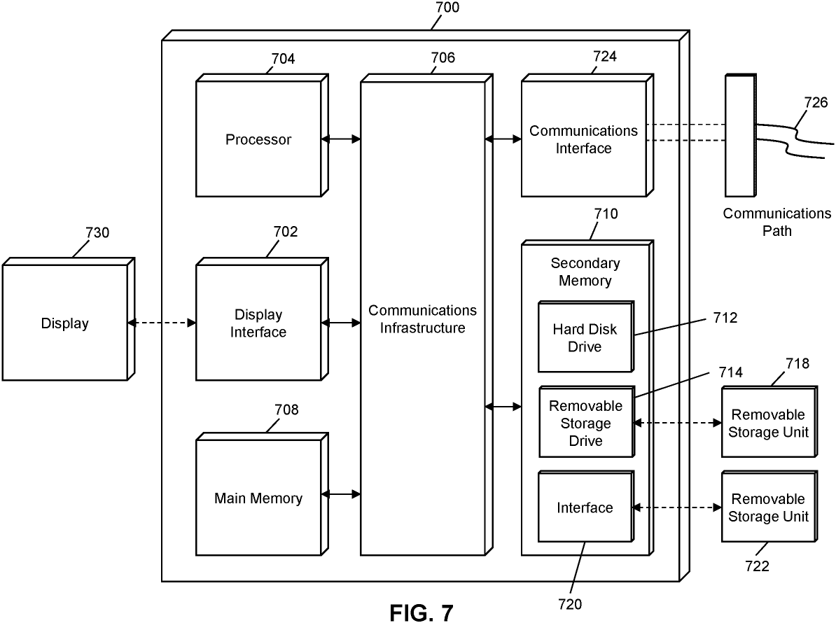

Once the processing server 102 has generated the hash value for the computing object and its associated state, the hash value may be published on a blockchain. The blockchain may be managed and maintained by a blockchain network 108. Each blockchain network 108 may be comprised of a plurality of different blockchain nodes 110. Each blockchain node 110 may be a computing system, such as illustrated in FIGS. 2 and 7, discussed in more detail below, that is configured to perform functions related to the processing and management of the blockchain, including the generation of blockchain data values, verification of proposed blockchain transactions, verification of digital signatures, generation of new blocks, validation of new blocks, and maintenance of a copy of the blockchain. In some embodiments, the processing server 102 may be a blockchain node 110 in the blockchain network 108.

The blockchain may be a distributed ledger that is comprised of at least a plurality of blocks. Each block may include at least a block header and one or more data values. Each block header may include at least a timestamp, a block reference value, and a data reference value. The timestamp may be a time at which the block header was generated, and may be represented using any suitable method (e.g., UNIX timestamp, DateTime, etc.). The block reference value may be a value that references an earlier block (e.g., based on timestamp) in the blockchain. In some embodiments, a block reference value in a block header may be a reference to the block header of the most recently added block prior to the respective block. In an exemplary embodiment, the block reference value may be a hash value generated via the hashing of the block header of the most recently added block. The data reference value may similarly be a reference to the one or more data values stored in the block that includes the block header. In an exemplary embodiment, the data reference value may be a hash value generated via the hashing of the one or more data values. For instance, the block reference value may be the root of a Merkle tree generated using the one or more data values.

The use of the block reference value and data reference value in each block header may result in the blockchain being immutable. Any attempted modification to a data value would require the generation of a new data reference value for that block, which would thereby require the subsequent block’s block reference value to be newly generated, further requiring the generation of a new block reference value in every subsequent block. This would have to be performed and updated in every single blockchain node 110 in the blockchain network 108 prior to the generation and addition of a new block to the blockchain in order for the change to be made permanent. Computational and communication limitations may make such a modification exceedingly difficult, if not impossible, thus rendering the blockchain immutable.

In the system 100, a blockchain node 110 (e.g., the processing server 102) may receive the hash value for the computing object and its associated state as well as any identification information (e.g., the identification value for the computing object and a state identifier). The hash value and associated identification information may be stored in a new blockchain data value that is generated and included in a new block that is generated and added to the blockchain using suitable methods. The new block may be distributed to all blockchain nodes 110 in the blockchain network 108. In cases where the blockchain may be a public blockchain, the new block may be accessible by any interested entity, such as by the state device 104 to ensure that the state data was properly stored in the tamper-resistant blockchain.

The processing server 102 may continue to generate hash values at regular intervals. In some cases, each time an action or event occurs that affects the state of the computing object, a new hash value may be generated for the computing object using its updated state data. In other cases, new hash values may be generated periodically, such as after predetermined periods of time (e.g., hourly, daily, weekly, etc., as may be depending on the computing object and its changes of state), after predetermined numbers of actions or events, after a predetermined number of state-changing actions or events, etc.

In the system 100, the processing server 102, state device 104, or another interested entity or system, such as a verifying system 106, may be interested in verifying state data for the computing object. For instance, if the computing object is an operating system, the verifying system 106 may utilize the operating system and may apply updates to the operating system. The verifying system 106 may wish to ensure that the updated operating system is valid and has not been tampered with (e.g., by the verifying system 106 being provided with malicious update data by a nefarious actor). The verifying system 106 may verify the updated state of the operating system using the appropriate hash value stored in the blockchain, either directly or via the processing server 102.

In an example embodiment, the verifying system 106 may electronically transmit the current state data for its computing object to the processing server 102 along with any identifying information, such as the unique identification value for the operating system and a version number as a state identifier for the operating system. The processing server 102 may receive the state data and identification information from the verifying system 106. The processing server 102 may convert the state data if necessary and then apply the cryptographic function to the state data to generate a new hash value. The processing server 102 may identify a published hash value for the computing object in the blockchain using the provided identification value and state identifier. The processing server 102 can then verify the state of the computing object possessed by the verifying system 106 may checking the generated new hash value with the published hash value. If the values match, then the computing object (e.g., the updated operating system) is considered verified. The processing server 102 can inform the verifying system 106 accordingly, and the verifying system 106 can utilize the operating system with confidence. If the hash values do not match, then the processing server 102 may inform the verifying system 106 of the instance, where the verifying system 106 may then desire to revert the computing object to an earlier state that had been successfully verified. As a result, any entity can verify the state of a computing object using the immutable hash values stored in the blockchain with the state data being completely resistant to tampering.

In cases where new hash values are regularly published for the computing object, the published hashed state data can be used to identify when local state data for the computing object (e.g., the verifying system’s version of the operating system) was corrupted in instances where a verification may fail. For example, the verifying system 106 may have successfully verified version 12 of the operating system, utilized the operating system for a period of time going through several updates, and then attempted a verification with version 18 of the operating system that may fail verification, such as due to receiving tampered-with update data for one of the versions between 12 and 18. After version 18 fails its verification data, the verifying system 106 may provide state data for version 17 of its operating system to the processing server 102 to attempt another validation. If that validation fails, the verifying system 106 may continue to test the versions of the operating system until another successful verification occurs. For instance, if version 15 fails its verification but version 14 has a successful verification, then the verifying system 106 can be certain that the update data for version 15 was tampered with. The verifying system 106 can then revert to version 14 and acquire valid update data, such as directly from the state device 104 or other entity, and perform a new verification once the operating system is updated. In some cases, the verifying system 106 may provide the processing server 102 with version 12 of the operating system and then the update data (e.g., or other event or action data in other examples) for each of the versions up to version 18. The processing server 102 may update the state data using the update data for version 13 and verify the updated state data using the associated hash value in the blockchain, and continue to update the state data and verify the updated operating systems until the verifications fail. In other words, the processing server 102 or any other entity may work in either direction to identify when tampering may have occurred to result in a failed verification of state data.

In another example, the state device 104 may be a database for a financial institution, such as a bank, where the computing object may be a bank account whose data is stored in the database. In such an example, state data for the bank account may be hashed and published to the blockchain, such as when the account is opened, when a deposit is made, when a withdrawal is made, etc. The published state data can be used to verify the status of an account (e.g., balance) at a given point in time. By publishing state data when the state of the account changes, credits made to the account or debits made to the account could be verified. For example, a dispute may arise between the account owner and a business, where the business may allege that the owner never made an alleged payment. The account owner may be able to provide data for the account prior to the payment, which can be hashed and the published state data on the blockchain used to verify the purported state before the payment. The account owner can then present the account after the payment, which can again be hashed and independently verified by the business or a verifying system 106, which would prove that the payment was made and account affected accordingly.

The methods and systems discussed herein enable event sourcing data or state data for a computing object to be stored in a manner that is completely tamper-resistant while at the same time being fully verifiable. The use of a blockchain ensures that the state data cannot be tampered with and yet still be used for verification. Using a cryptographic hash function also ensures that verification can occur while also allowing the state data to be stored in a publicly-accessible distributed ledger without comprising any sensitive or confidential data. Thus, an entity that has an application program available may have its state data always updated and published on the blockchain to enable all customers to verify versions of the application program in an easy and safe manner to and to easily and quickly identify when any tampering with local copies of the application program may occur. Thus, the methods and systems discussed herein provide for technical improvements to event sourcing and the storage and verification of state data through the use of cryptographic functions and blockchains.

### Processing Server

FIG. 2 illustrates an embodiment of a processing server 102, such as the processing server 102 in the system 100. It will be apparent to persons having skill in the relevant art that the embodiment of the processing server 102 illustrated in FIG. 2 is provided as illustration only and may not be exhaustive to all possible configurations of the processing server 102 suitable for performing the functions as discussed herein. For example, the computer system 700 illustrated in FIG. 7 and discussed in more detail below may be a suitable configuration of the processing server 102.

The processing server 102 may include a receiving device 202. The receiving device 202 may be configured to receive data over one or more networks via one or more network protocols. In some instances, the receiving device 202 may be configured to receive data from state devices 104, verifying systems 106, blockchain nodes 110, and other systems and entities via one or more communication methods, such as radio frequency, local area networks, wireless area networks, cellular communication networks, Bluetooth, the Internet, etc. In some embodiments, the receiving device 202 may be comprised of multiple devices, such as different receiving devices for receiving data over different networks, such as a first receiving device for receiving data over a local area network and a second receiving device for receiving data via the Internet. The receiving device 202 may receive electronically transmitted data signals, where data may be superimposed or otherwise encoded on the data signal and decoded, parsed, read, or otherwise obtained via receipt of the data signal by the receiving device 202. In some instances, the receiving device 202 may include a parsing module for parsing the received data signal to obtain the data superimposed thereon. For example, the receiving device 202 may include a parser program configured to receive and transform the received data signal into usable input for the functions performed by the processing device to carry out the methods and systems described herein.

The receiving device 202 may be configured to receive data signals electronically transmitted by blockchain nodes 110, which may be superimposed or otherwise encoded with blockchain data values, blocks, blockchain transaction data, etc. The receiving device 202 may also be configured to receive data signals electronically transmitted by state devices 104 that may be superimposed or otherwise encoded with state data, event sourcing data, update data, event or action data, identification values, state identifiers, etc. The receiving device 202 may also be configured to receive data signals electronically transmitted by verifying systems 106, which may be superimposed or otherwise encoded with state data, identification values, state identifiers, update data, event or action data, etc.

The processing server 102 may also include a communication module 204. The communication module 204 may be configured to transmit data between modules, engines, databases, memories, and other components of the processing server 102 for use in performing the functions discussed herein. The communication module 204 may be comprised of one or more communication types and utilize various communication methods for communications within a computing device. For example, the communication module 204 may be comprised of a bus, contact pin connectors, wires, etc. In some embodiments, the communication module 204 may also be configured to communicate between internal components of the processing server 102 and external components of the processing server 102, such as externally connected databases, display devices, input devices, etc. The processing server 102 may also include a processing device. The processing device may be configured to perform the functions of the processing server 102 discussed herein as will be apparent to persons having skill in the relevant art. In some embodiments, the processing device may include and/or be comprised of a plurality of engines and/or modules specially configured to perform one or more functions of the processing device, such as a querying module 214, generation module 216, verification module 218, etc. As used herein, the term “module” may be software or hardware particularly programmed to receive an input, perform one or more processes using the input, and provides an output. The input, output, and processes performed by various modules will be apparent to one skilled in the art based upon the present disclosure.

The processing server 102 may include blockchain data 206, which may be stored in a memory 212 of the processing server 102 or stored in a separate area within the processing server 102 or accessible thereby. The blockchain data 206 may include a blockchain, which may be comprised of a plurality of blocks and be associated with the blockchain network 108. The blockchain data 206 may also or alternatively include any data associated with a blockchain, such as cryptographic key pairs, network identifiers for blockchain networks 108, cryptographic algorithms, formatting rules, signature algorithms, etc.

The processing server 102 may also include a memory 212. The memory 212 may be configured to store data for use by the processing server 102 in performing the functions discussed herein, such as public and private keys, symmetric keys, etc. The memory 212 may be configured to store data using suitable data formatting methods and schema and may be any suitable type of memory, such as read-only memory, random access memory, etc. The memory 212 may include, for example, encryption keys and algorithms, communication protocols and standards, data formatting standards and protocols, program code for modules and application programs of the processing device, and other data that may be suitable for use by the processing server 102 in the performance of the functions disclosed herein as will be apparent to persons having skill in the relevant art. In some embodiments, the memory 212 may be comprised of or may otherwise include a relational database that utilizes structured query language for the storage, identification, modifying, updating, accessing, etc. of structured data sets stored therein. The memory 212 may be configured to store, for example, cryptographic keys, salts, nonces, communication information for other computing systems, cryptographic functions, formatting rules, representation data, cryptographic key pairs, canonicalization schemes, etc.

The processing server 102 may include a querying module 214. The querying module 214 may be configured to execute queries on databases to identify information. The querying module 214 may receive one or more data values or query strings, and may execute a query string based thereon on an indicated database, such as the blockchain data 206 of the processing server 102 to identify information stored therein. The querying module 214 may then output the identified information to an appropriate engine or module of the processing server 102 as necessary. The querying module 214 may, for example, execute a query on the blockchain data 206 to identify a published hash value using a provided identification value and state identifier to compare with a generated hash value to validate supplied state data.

The processing server 102 may also include a generation module 216. The generation module 216 may be configured to generate data for use by the processing server 102 in performing the functions discussed herein. The generation module 216 may receive instructions as input, may generate data based on the instructions, and may output the generated data to one or more modules of the processing server 102. For example, the generation module 216 may be configured to apply cryptographic functions to state data to generate hash values, such as applying one-way cryptographic hash functions to event sourcing or state data to generate unique and/or collision-resistant hash values. In cases where the processing server 102 may be a blockchain node 110, the generation module 216 may also be configured to generate cryptographic key pairs, generate digital signatures, generate blockchain data values, generate new blocks, generate block and data reference values, aggregate state changes, generate genesis block records, etc.

The processing server 102 may also include a verification module 218. The verification module 218 may be configured to perform verifications for the processing server 102 as part of the functions discussed herein. The verification module 218 may receive instructions as input, which may also include data to be used in performing a verification, may perform a verification as requested, and may output a result of the verification to another module or engine of the processing server 102. The verification module 218 may, for example, be configured to verify received state data by hashing the state data and comparing the resulting hash value with a hash value published on a blockchain. In some cases the verification module 218 may perform a series of verifications to determine an action or event that results in a failed verification to identify an action or event that may have been tampered with.

The processing server 102 may also include a transmitting device 220. The transmitting device 220 may be configured to transmit data over one or more networks via one or more network protocols. In some instances, the transmitting device 220 may be configured to transmit data to state devices 104, verifying systems 106, blockchain nodes 110, and other entities via one or more communication methods, local area networks, wireless area networks, cellular communication, Bluetooth, radio frequency, the Internet, etc. In some embodiments, the transmitting device 220 may be comprised of multiple devices, such as different transmitting devices for transmitting data over different networks, such as a first transmitting device for transmitting data over a local area network and a second transmitting device for transmitting data via the Internet. The transmitting device 220 may electronically transmit data signals that have data superimposed that may be parsed by a receiving computing device. In some instances, the transmitting device 220 may include one or more modules for superimposing, encoding, or otherwise formatting data into data signals suitable for transmission.

The transmitting device 220 may be configured to electronically transmit data signals to blockchain nodes 110, which may be superimposed or otherwise encoded with blockchain data values, blocks, blockchain transaction data, proposed genesis block records, state database data, smart contract state data, confirmation messages, etc. The transmitting device 220 may also be configured to electronically transmit data signals to state devices 104 that may be superimposed or otherwise encoded with generated hash values, blockchain data values, notifications regarding the publishing of state data, requests for state data or event sourcing data, etc. The transmitting device 220 may also be configured to electronically transmit data signals to verifying systems 106, which may be superimposed or otherwise encoded with notifications regarding performed verifications, requests for state data or identification data, etc. Process for Publishing Tamper-Resistant Event Sourcing Data

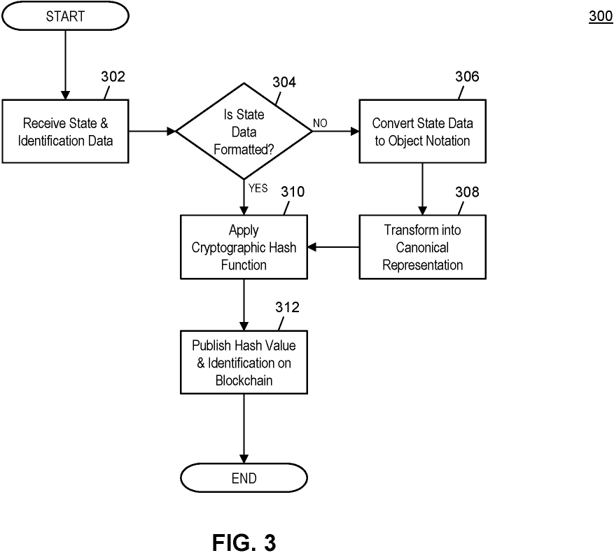

FIG. 3 illustrates a process 300 for the publishing state or event sourcing data that is tamper-resistant on a blockchain in the system 100 as performed by the processing server 102.

In step 302, the receiving device 202 of the processing server 102 may receive state data or event sourcing data for a computing object and identification data, such as an identification value associated with the computing object and a state identifier associated with the supplied state data, from a state device 104 or other suitable system using a suitable communication network and method. In step 304, the processing server 102 may determine if the received state data is properly formatted for being hashed. The determination may be performed by any suitable component of the processing server 102 and may involve comparing the received state data with one or more criteria, guidelines, etc. that may be stored in or otherwise accessible to the processing server 102. If the state data is not formatted, then, in step 306, the generation module 216 of the processing server 102 may convert the state data to an object notation representation, such as a JSON representation, though other options are available. In step 308, the generation module 216 of the processing server 102 may then transform the state data from its JSON representation to a canonical representation, such as using the JCS or another canonicalization scheme.

After the state data has been transformed into the canonical representation, or if, in step 304, the processing server 102 determined that the state data was already suitably formatted, then, in step 310, the generation module 216 of the processing server 102 may apply a cryptographic hashing function to the formatted state data. The cryptographic hashing function may be a one-way hashing function of sufficient complexity to be collision resistant. The application of the cryptographic function to the formatted state data may produce a hash value for the state of the computing object. In step 312, the transmitting device 220 of the processing server 102 may electronically transmit the generated hash value, identification value, and state identifier to a blockchain node 110 in the blockchain network 108 for publishing of the data in a new blockchain data value that is included in a new block that is confirmed and added to the blockchain. In some embodiments, the processing server 102 may also transmit, via the transmitting device 220, a notification message to the state device 104 indicating that the hash value was successfully published, which may include the hash value and/or any confirmation data received from the blockchain node 110. The hash value may then be stored in the tamper-resistant blockchain for use in verifying the state of the computing object.

### Process for Verifying State of a Computing Object

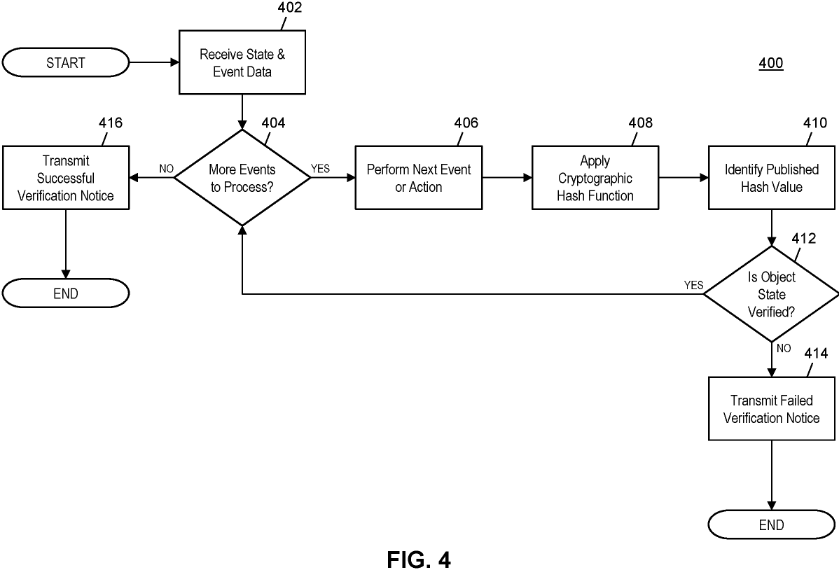

FIG. 4 illustrates a process 400 for verifying the state of a computing object using tamper-resistant storage of event sourcing or state data via a blockchain as performed by the processing server 102 in the system 100. The process 400 illustrates an example where the processing server 102 may receive a plurality of events and may perform verifications for the state of the computing object through execution of each of the events. It will be apparent to persons having skill in the relevant art that the process 400 may differ in cases where a single set of state data is to be performed or where the processing server 102 is provided with sets of state data without any accompanying event data.

In step 402, the receiving device 202 of the processing server 102 may receive state data for a computing object and event data, where the event data may comprise a plurality of different actions or events that, when applied to or executed by the computing object, may modify the state data. In some cases, the event data may include a specific ordering for application of the action or event data. In some instances, each action or event in the event data may have a state identifier associated therewith as provided to the processing server 102. The data may be received from the verifying system 106 using a suitable communication network and method.

In step 404, the processing server 102 may determine if there are any actions or events left in the received event data for which a verification is to be performed. If there are still one or more actions or events remaining, then, in step 406, the processing server 102 may perform the next event or action. The processing server 102 may identify the next event or action using a provided ordering, timestamp data, etc. The execution of the event or action may update the state data, such as either directly modifying the state data or by executing the action using an application program that modifies the application program or associated data and then identifying state data therefrom. In step 408, the generation module 216 of the processing server 102 may apply a cryptographic hashing function to the state data. The cryptographic hashing function may be a one-way hashing function of sufficient complexity to be collision resistant. The application of the cryptographic function to the state data may produce a hash value for the state of the computing object. In some embodiments, the processing server 102 may first format the state data, such as described above with respect to steps 306 and 308 as illustrated in FIG. 3.

Once the hash value has been generated, then, in step 410, the processing server 102 may identify a published hash value for the computing object and the state resulting from the performance of the event or action from step 406 in the blockchain associated with the blockchain network 108. The published hash value may be identified using the identification value associated with the computing object as well as the state identifier associated with the event or action that was executed in step 406. In step 412, the processing server 102 may determine if the state for the computing object can be successfully verified, such as by the verification module 218 of the processing server 102 performing a verification by checking for a match of the generated hash value with the identified, published hash value.

If the verification is unsuccessful, such as because the two hash values do not match, then, in step 414, the transmitting device 220 of the processing server 102 may electronically transmit a notification message to the verifying system 106 indicating that the verification failed. In some cases, the notification message may include the state identifier or other information indicating the event or action that was performed prior to the failed verification. In such cases, the notification may enable the verifying system 106 or other entity to identify when an action or event had been tampered with, when event sourcing data had been tampered with, etc.

If the verification in step 412 is successful, then the process 400 may return to step 404 where the processing server 102 may determine if there are more actions or events in the received event data to be performed. If there are, then the processing server 102 may return to step 406 and continue the process 400 working through each of the actions or events as long as the verifications are successful. If all of the actions or events have been performed and every verification is successful, as determined by returning to step 404 and the processing server 102 determining that there are no more actions left to perform, then the process 400 may proceed to step 416 where the transmitting device 220 of the processing server 102 may electronically transmit a notification message to the verifying system 106 indicating that the verifications were all successful. The verifying system 106 may then proceed to utilize the computing object with confidence that no tampering had been performed on the computing object or its event sourcing data.

### Exemplary Method for Tamper-Resistant Event Sourcing

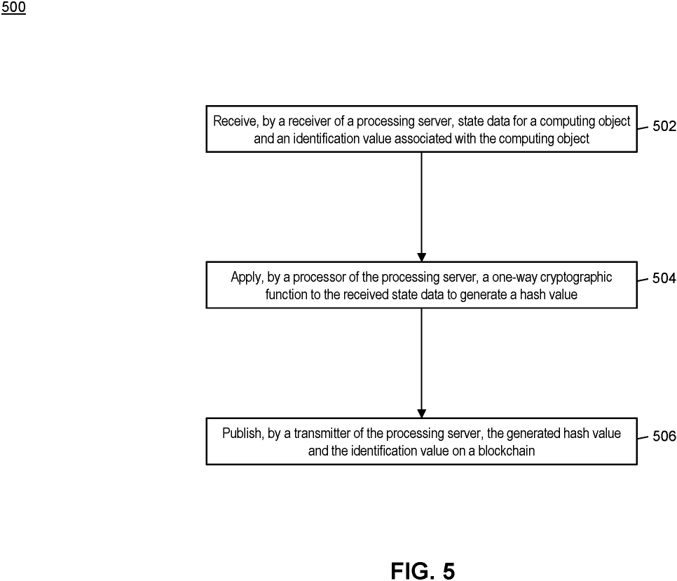

FIG. 5 illustrates a method 500 for the tamper-resistant event sourcing of a computing object through the use of cryptographic functions and blockchains.

In step 502, state data for a computing object and an identification value associated with the computing object may be received by a receiver (e.g., receiving device 202) of a processing server (e.g., the processing server 102). In step 504, a one-way cryptographic function may be applied to the received state data by a processor (e.g., generation module 216) of the processing server to generate a hash value. In step 506, the generated hash value and the identification value may be published on a blockchain by a transmitter (e.g., transmitting device 220) of the processing server.

In one embodiment, the method 500 may further include converting, by the processor (e.g., generation module 216) of the processing server, the state data into an object notation representation prior to applying the one-way cryptographic function. In a further embodiment, the object notation representation may be a JavaScript Object Notation representation. In another further embodiment, the method 500 may even further include transforming, by the processor (e.g., generation module 216) of the processing server, the converted state data into a canonical representation prior to applying the one-way cryptographic function. In an even further embodiment, the converted state data may be transformed in compliance with the JavaScript Object Notation (JSON) Canonicalization Scheme (JCS).

### Exemplary Method for Verifying Object State

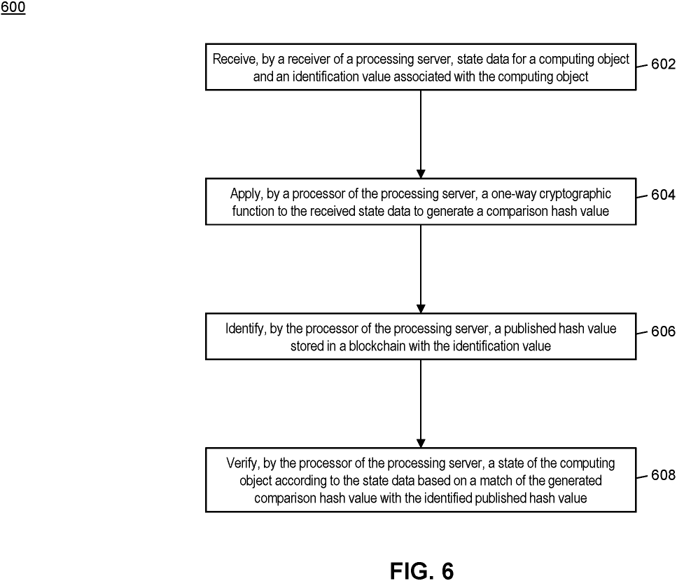

FIG. 6 illustrates a method 600 for verifying the state of a computing object through tamper-resistant event sourcing via a blockchain.

In step 602, state data for a computing object and an identification value associated with the computing object may be received by a receiver (e.g., receiving device 202) of a processing server (e.g., the processing server 102). In step 604, a one-way cryptographic function may be applied to the received state data by a processor (e.g., generation module 216) of the processing server to generate a hash value.

In step 606, a published hash value stored in a blockchain with the identification value may be identified by the processor (e.g., querying module 214) of the processing server. In step 608, a state of the computing object according to the state data may be verified by the processor (e.g., verification module 218) of the processing server based on a match of the generated comparison hash value with the identified published hash value.

In one embodiment, the method 600 may also include repeating, by the processing server, the receiving, applying, identifying, and verifying steps for a plurality of states for the computing object, where each state of the plurality of states includes a different set of state data. In a further embodiment, verification of the state of the computing object may fail for one of the plurality of states and the method 600 may further include transmitting, by a transmitter (e.g., transmitting device 220) of the processing server, a notification message identifying the one of the plurality of states that resulted in failed verification.

### Computer System Architecture

FIG. 7 illustrates a computer system 700 in which embodiments of the present disclosure, or portions thereof, may be implemented as computer-readable code. For example, the processing server 102 of FIGS. 1 and 2 may be implemented in the computer system 700 using hardware, non-transitory computer readable media having instructions stored thereon, or a combination thereof and may be implemented in one or more computer systems or other processing systems. Hardware may embody modules and components used to implement the methods of FIGS. 3-6.

If programmable logic is used, such logic may execute on a commercially available processing platform configured by executable software code to become a specific purpose computer or a special purpose device (e.g., programmable logic array, application-specific integrated circuit, etc.). A person having ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device. For instance, at least one processor device and a memory may be used to implement the above described embodiments.

A processor unit or device as discussed herein may be a single processor, a plurality of processors, or combinations thereof. Processor devices may have one or more processor “cores.” The terms “computer program medium,” “non-transitory computer readable medium,” and “computer usable medium” as discussed herein are used to generally refer to tangible media such as a removable storage unit 718, a removable storage unit 722, and a hard disk installed in hard disk drive 712.

Various embodiments of the present disclosure are described in terms of this example computer system 700. After reading this description, it will become apparent to a person skilled in the relevant art how to implement the present disclosure using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

Processor device 704 may be a special purpose or a general purpose processor device specifically configured to perform the functions discussed herein. The processor device 704 may be connected to a communications infrastructure 706, such as a bus, message queue, network, multi-core message-passing scheme, etc. The network may be any network suitable for performing the functions as disclosed herein and may include a local area network (LAN), a wide area network (WAN), a wireless network (e.g., WiFi), a mobile communication network, a satellite network, the Internet, fiber optic, coaxial cable, infrared, radio frequency (RF), or any combination thereof. Other suitable network types and configurations will be apparent to persons having skill in the relevant art. The computer system 700 may also include a main memory 708 (e.g., random access memory, read-only memory, etc.), and may also include a secondary memory 710. The secondary memory 710 may include the hard disk drive 712 and a removable storage drive 714, such as a floppy disk drive, a magnetic tape drive, an optical disk drive, a flash memory, etc.

The removable storage drive 714 may read from and/or write to the removable storage unit 718 in a well-known manner. The removable storage unit 718 may include a removable storage media that may be read by and written to by the removable storage drive 714. For example, if the removable storage drive 714 is a floppy disk drive or universal serial bus port, the removable storage unit 718 may be a floppy disk or portable flash drive, respectively. In one embodiment, the removable storage unit 718 may be non-transitory computer readable recording media.

In some embodiments, the secondary memory 710 may include alternative means for allowing computer programs or other instructions to be loaded into the computer system 700, for example, the removable storage unit 722 and an interface 720. Examples of such means may include a program cartridge and cartridge interface (e.g., as found in video game systems), a removable memory chip (e.g., EEPROM, PROM, etc.) and associated socket, and other removable storage units 722 and interfaces 720 as will be apparent to persons having skill in the relevant art.

Data stored in the computer system 700 (e.g., in the main memory 708 and/or the secondary memory 710) may be stored on any type of suitable computer readable media, such as optical storage (e.g., a compact disc, digital versatile disc, Blu-ray disc, etc.) or magnetic tape storage (e.g., a hard disk drive). The data may be configured in any type of suitable database configuration, such as a relational database, a structured query language (SQL) database, a distributed database, an object database, etc. Suitable configurations and storage types will be apparent to persons having skill in the relevant art.

The computer system 700 may also include a communications interface 724. The communications interface 724 may be configured to allow software and data to be transferred between the computer system 700 and external devices. Exemplary communications interfaces 724 may include a modem, a network interface (e.g., an Ethernet card), a communications port, a PCMCIA slot and card, etc. Software and data transferred via the communications interface 724 may be in the form of signals, which may be electronic, electromagnetic, optical, or other signals as will be apparent to persons having skill in the relevant art. The signals may travel via a communications path 726, which may be configured to carry the signals and may be implemented using wire, cable, fiber optics, a phone line, a cellular phone link, a radio frequency link, etc.

The computer system 700 may further include a display interface 702. The display interface 702 may be configured to allow data to be transferred between the computer system 700 and external display 730. Exemplary display interfaces 702 may include high-definition multimedia interface (HDMI), digital visual interface (DVI), video graphics array (VGA), etc. The display 730 may be any suitable type of display for displaying data transmitted via the display interface 702 of the computer system 700, including a cathode ray tube (CRT) display, liquid crystal display (LCD), light-emitting diode (LED) display, capacitive touch display, thin-film transistor (TFT) display, etc.

Computer program medium and computer usable medium may refer to memories, such as the main memory 708 and secondary memory 710, which may be memory semiconductors (e.g., DRAMs, etc.). These computer program products may be means for providing software to the computer system 700. Computer programs (e.g., computer control logic) may be stored in the main memory 708 and/or the secondary memory 710. Computer programs may also be received via the communications interface 724. Such computer programs, when executed, may enable computer system 700 to implement the present methods as discussed herein. In particular, the computer programs, when executed, may enable processor device 704 to implement the methods illustrated by FIGS. 3-6, as discussed herein. Accordingly, such computer programs may represent controllers of the computer system 700. Where the present disclosure is implemented using software, the software may be stored in a computer program product and loaded into the computer system 700 using the removable storage drive 714, interface 720, and hard disk drive 712, or communications interface 724.

The processor device 704 may comprise one or more modules or engines configured to perform the functions of the computer system 700. Each of the modules or engines may be implemented using hardware and, in some instances, may also utilize software, such as corresponding to program code and/or programs stored in the main memory 708 or secondary memory 710. In such instances, program code may be compiled by the processor device 704 (e.g., by a compiling module or engine) prior to execution by the hardware of the computer system 700. For example, the program code may be source code written in a programming language that is translated into a lower level language, such as assembly language or machine code, for execution by the processor device 704 and/or any additional hardware components of the computer system 700. The process of compiling may include the use of lexical analysis, preprocessing, parsing, semantic analysis, syntax-directed translation, code generation, code optimization, and any other techniques that may be suitable for translation of program code into a lower level language suitable for controlling the computer system 700 to perform the functions disclosed herein. It will be apparent to persons having skill in the relevant art that such processes result in the computer system 700 being a specially configured computer system 700 uniquely programmed to perform the functions discussed above.

Techniques consistent with the present disclosure provide, among other features, systems and methods for tamper-resistant event sourcing and verifying the state of an object through tamper-resistant event sourcing. While various exemplary embodiments of the disclosed system and method have been described above it should be understood that they have been presented for purposes of example only, not limitations. It is not exhaustive and does not limit the disclosure to the precise form disclosed. Modifications and variations are possible in light of the above teachings or may be acquired from practicing of the disclosure, without departing from the breadth or scope.

What is claimed is:

1. A method for tamper-resistant event sourcing of an object, comprising:
receiving, by a receiver of a processing server, state data for a computing object and an identification value associated with the computing object;
applying, by a processor of the processing server, a one-way cryptographic function to the received state data to generate a hash value; and
publishing, by a transmitter of the processing server, the generated hash value and the identification value on a blockchain.

2. The method of claim 1, further comprising:
converting, by the processor of the processing server, the state data into an object notation representation prior to applying the one-way cryptographic function.

3. The method of claim 2, wherein the object notation representation is a JavaScript Object Notation representation.

4. The method of claim 2, further comprising:
transforming, by the processor of the processing server, the converted state data into a canonical representation prior to applying the one-way cryptographic function.

5. The method of claim 4, wherein the converted state data is transformed in compliance with the JavaScript Object Notation (JSON) Canonicalization Scheme (JCS).

6. A method for verifying the state of an object through tamper-resistant event sourcing, comprising:
receiving, by a receiver of a processing server, state data for a computing object and an identification value associated with the computing object;
applying, by a processor of the processing server, a one-way cryptographic function to the received state data to generate a comparison hash value;
identifying, by the processor of the processing server, a published hash value stored in a blockchain with the identification value; and
verifying, by the processor of the processing server, a state of the computing object according to the state data based on a match of the generated comparison hash value with the identified published hash value.

7. The method of claim 6, further comprising:
repeating, by the processing server, the receiving, applying, identifying, and verifying steps for a plurality of states for the computing object, where each state of the plurality of states includes a different set of state data.

8. The method of claim 7, wherein
verification of the state of the computing object fails for one of the plurality of states, and
the method further comprises:
transmitting, by a transmitter of the processing server, a notification message identifying the one of the plurality of states that resulted in failed verification.

9. A system for tamper-resistant event sourcing of an object, comprising:
a processing server, the processing server including
a receiver receiving state data for a computing object and an identification value associated with the computing object,
a processor applying a one-way cryptographic function to the received state data to generate a hash value, and
a transmitter publishing the generated hash value and the identification value on a blockchain.

10. The system of claim 9, wherein the processor of the processing server converts the state data into an object notation representation prior to applying the one-way cryptographic function.

11. The system of claim 10, wherein the object notation representation is a JavaScript Object Notation representation.

12. The system of claim 10, wherein the processor of the processing server transforms the converted state data into a canonical representation prior to applying the one-way cryptographic function.

13. The system of claim 12, wherein the converted state data is transformed in compliance with the JavaScript Object Notation (JSON) Canonicalization Scheme (JCS).

14. A system for verifying the state of an object through tamper-resistant event sourcing, comprising:
a processing server, the processing server including
a receiver receiving state data for a computing object and an identification value associated with the computing object, and
a processor
applying a one-way cryptographic function to the received state data to generate a comparison hash value,
identifying a published hash value stored in a blockchain with the identification value, and
verifying a state of the computing object according to the state data based on a match of the generated comparison hash value with the identified published hash value.

15. The system of claim 14, wherein the processing server repeats the receiving, applying, identifying, and verifying for a plurality of states for the computing object, where each state of the plurality of states includes a different set of state data.

16. The system of claim 15, wherein
verification of the state of the computing object fails for one of the plurality of states, and
the processing server further includes a transmitter transmitting a notification message identifying the one of the plurality of states that resulted in failed verification.
